(19) United States
(12) Patent Application Publication
(10) Pub. No.: US 2023/0371491 A1
(43) Pub. Date: Nov. 23, 2023

(54) INSECT TRAPPING LIGHT

(71) Applicant: KP Solutions, Inc., Lucedale, MS (US)

(72) Inventors: Keith Adonnis Parnell, Lucedale, MS (US); Jessie Leigh Parnell, Lucedale, MS (US)

(21) Appl. No.: 18/228,931

(22) Filed: Aug. 1, 2023

Related U.S. Application Data
(63) Continuation-in-part of application No. 17/376,773, filed on Jul. 15, 2021.
Application No. 17/376,773 is a continuation-in-part of application No. 16/276,247, filed on Feb. 14, 2019, now Pat. No. 11,109,583.

(51) Int. Cl. A01M 1/14; A01M 1/10; G09F 9/30

(52) U.S. Cl. CPC A01M 1/145; A01M 1/106; G09F 9/30

(57) ABSTRACT

An insect trapping light is shown having a visible light housing, a pair of electronic display screens, and an insect trapping housing. The display screen may be a television screen, picture display screen, movie display screen, computer monitor or display, or the like. The insect trapping housing has a bottom space configured to removably receive an insect bait tray that may be filled with an insect baiting substance to attract insects. The insect trapping housing and the visible light housing combine to form a UV light space or chamber therebetween. An adhesive board is slidably received and held in place upon the visible light housing surface facing the UV light chamber. The spacing between the insect trapping housing and the visible light housing defines the UV light chamber having open sides The UV light chamber also includes a matrix or array of UV lights or light sources.

### CROSS REFERENCE TO RELATED APPLICATIONS

This is a continuation-in-part of U.S. patent application Ser. No. 17/376,773 filed Jul. 15, 2021 and entitled INSECT TRAPPING LIGHT, which is a continuation-in-part of U.S. patent application Ser. No. 16/276,247 filed Feb. 14, 2019 and entitled INSECT TRAPPING LIGHT.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### FIELD OF THE INVENTION

The invention relates generally to a trap for flying insects, and more particularly to a trap for flying insects which provides signage capabilities.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Many flying insect traps have been devised to eliminate insects from a location. Many of these types of traps include an electrified grid surrounding an insect attracting light. The insect attracting light is typically an ultraviolet (UV) light. In use, as the insect is drawn to and approaches the UV light, it encounters the electrified grid wherein the insect is killed by the electric current. A problem with this type of insect trap is that it is not allowed in the food service industry as the electrification of the insect essentially causes it to explode and disperse the insect particles into the surrounding air.

As such, insect traps utilized in the food service industry typically utilize an adhesive board mounted adjacent to a UV light. The insect approaching the UV light encounters the adhesive board wherein the insect is adhered to the board and is unable to extricate itself. The adhesive board is removable so that the board and its contents may be exchanged with a new board from time to time. A problem associated with these types of insects traps is that they are unsightly in appearance. Furthermore, the patrons within the food establishment readily recognize the device as an insect light because of the glow emanating from the UV light. These patrons may be repulsed by the perception that this food establishment may have an insect problem. Furthermore, the patron will purposely sit in a location far away from the insect trap thinking that the trap will draw insects to that location.

A problem with insect traps has been that they are typically mounted upon a wall and thus restrict the use of any display associated with the device to one side of the insect trap.

Accordingly, it is seen that a need remains for an insect trap which provides a safe and effective manner of trapping insects while providing a pleasing appearance which does not convey to the public the presence of an insect light. It is to the provision of such therefore that the present invention is primarily directed.

### BRIEF SUMMARY OF THE INVENTION

In a preferred form of the invention, an insect trap light comprises an electronic display screen, an insect trapping housing portion coupled to the electronic display screen, the insect trapping housing portion creating a UV light chamber, a UV light source mounted within the UV light chamber, and an adhesive board removably mounted within the UV light chamber.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 is a perspective view of an insect trapping light embodying principles of the invention in a preferred form.

FIG. 2 is a perspective, exploded view of the insect trapping light of FIG. 1.

FIG. 3 is a side view of the insect trapping light of FIG. 1.

FIG. 4 is a cross-sectional side view of the insect trapping light of FIG. 1.

FIG. 5 is a perspective view of an insect trapping light embodying principles of the invention in another preferred form.

FIG. 6 is a schematic perspective view of an insect trapping light embodying principles of the invention in another preferred form.

FIG. 7 is a schematic exploded view of the insect trapping light of FIG. 6.

FIG. 8 is a schematic top view of the insect trapping light of FIG. 6.

FIG. 9 is a schematic bottom view of the insect trapping light of FIG. 6.

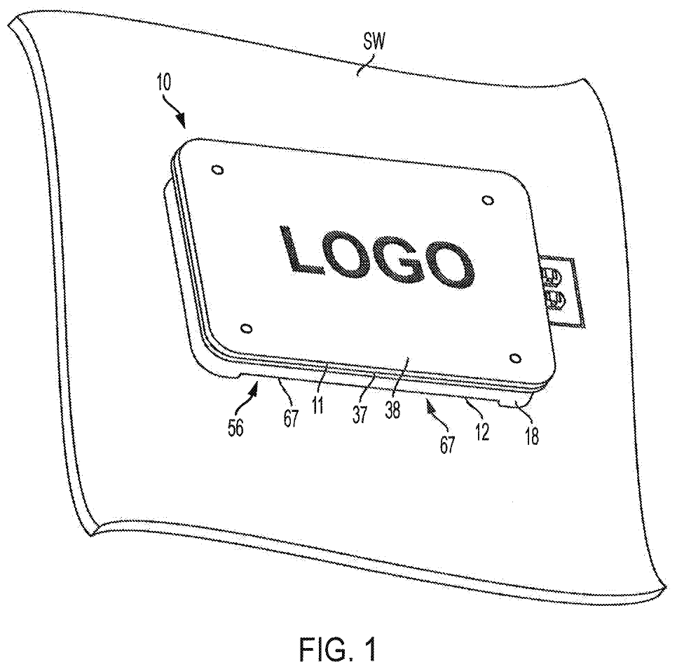

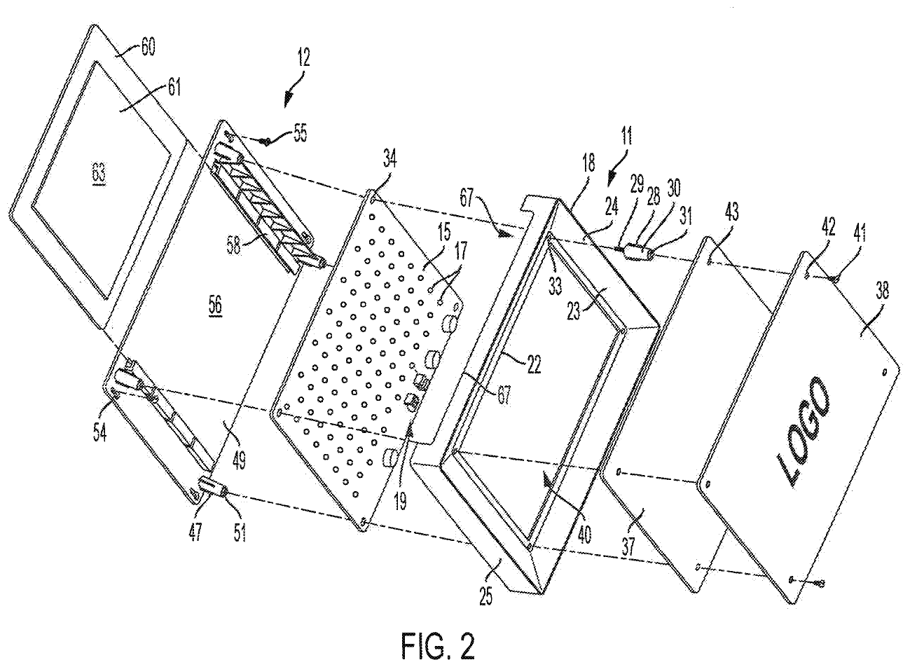

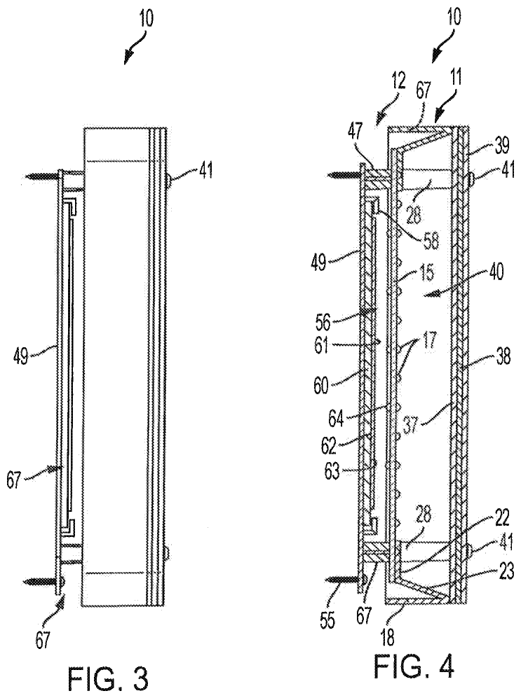

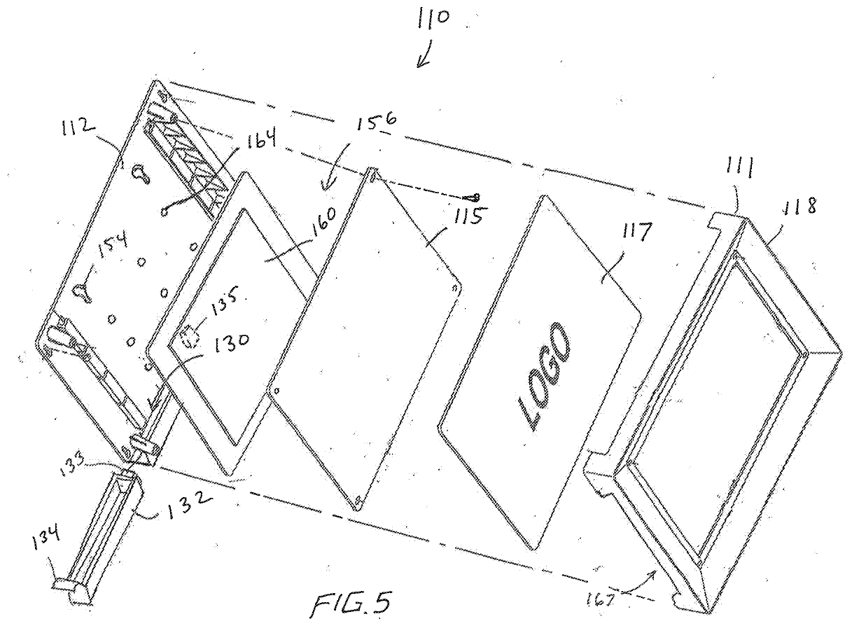

### DETAILED DESCRIPTION OF CERTAIN EMBODIMENTS

With reference next to the drawings, there is shown an insect trapping light 10 according to the present invention. The insect trapping light 10 is typically mounted to a vertical supporting wall of a room. The insect trapping light 10 includes a visible light housing portion, enclosure, or housing 11 and an insect trapping housing portion, enclosure or housing 12 coupled to the visible light housing 11.

As shown in the drawings, the insect trapping light 10 is generally rectangular or box shaped, however, it should be understood that the insect trapping light 10, the visible light housing 11, and/or the insect trapping housing 12 may be of any shape or configuration.

The visible light housing 11 includes a floor 15 having a matrix or array of white light or visible light lights or light sources 17, preferably in the form of white light emitting diodes (LEDs), and a rectangular, peripheral frame 18. The term white light is used herein, but is meant to include any visible light, including actual white light or any static or adjustable colored lights. The LEDs 17 are coupled to LED conventional circuitry 19 mounted to the floor 15, which in turn is coupled to an electric power source. The LED circuitry 19 may include an on/off switch for the visible light LEDs 17.

The rectangular frame 18 includes a base member 22 mounted flushly against the floor 15 and a side wall member 23 extending from the base member 22 having an interior surface 24 and an exterior surface 25. The rectangular frame 18 is coupled to the floor 15 through four threaded posts 28, each threaded post 28 having a bottom end 29 with external threads and a top end 30 having an internally threaded screw mounting hole 31. The threaded bottom end 29 extends through a screw mounting hole 33 in the frame base member 22 and into a spacer hole 34 in the floor 15 aligned with screw mounting holes 53.

A translucent light diffuser portion or plate 37 is positioned against the top edge of the side wall member 23 of the frame 18. The diffuser plate 37 may be made of a polymer or other material, such as an acrylic or high density polyethylene. A transparent or translucent decorative, advertisement, or logo plate 38 is positioned to overlay and generally conform to the peripheral configuration of the light diffuser plate 37. The logo plate 38 may be made of a polymer or other material, such as an acrylic or high density polyethylene. The term translucent used herein is intended to denote both transparent and translucent or diffusing light qualities. The logo plate 38 may be colored itself with a graphic or may include an indicia or graphic overlay or layer 39 adhered to either side of the logo plate 39, the graphic being shown in the drawings as the word “LOGO”. The graphic overlay 39 may be made of a polymer material, such as a vinyl material or the like. The diffuser plate 37 is mounted to the rectangular frame 18 such that there are no gaps or spaces which could enable an insect to enter the visible light housing 11.

Four mounting screws 41 extend through four screw mounting holes 42 in the logo plate 38 and four mutually aligned screw mounting holes 43 in the diffuser plate 37 and are threadably received into the screw mounting holes 31 of the threaded posts 28. The combination of the floor 15, frame 18, and light diffuser plate 37 form an enclosed visible light chamber 40, wherein the term enclosed means that the visible light chamber does not have openings which would allow insects access to the visible light chamber 40.

Four spacers 47 extend between the floor 15 and a mounting plate 49, with each spacer 47 having a top end 51 positioned within the floor spacer hole 34 so as to threadably receive the threaded bottom ends 29 of the posts 28 in order to couple the frame 18 to the floor 15. The spacers 47 provide for a UV light space or chamber 56 between and defined by the floor 15 and the mounting plate 49. The mounting plate 49, spacer 47 and floor 15 combine to define the insect trapping housing portion 12.

The mounting plate 49 also has four keyhole shaped mounting hole 54 extending therethrough which are configured to receive mounting screws 55 that extend into a supporting wall SW of a room.

The mounting plate 49 also has a pair of generally parallel, inverted L-shaped guides 58. An adhesive board 60 is slidably received and held in place between the L-shaped guides 58. The adhesive board 60 is coupled to one or more removable adhesive strips 61 which have a first adhesive surface 62 facing the adhesive board for mounting thereto and a second adhesive surface 63 adapted to capture insects coming in contact with the second adhesive surface 63.

The insect trapping housing portion 12 also includes a matrix or array of UV lights or light sources 64, preferably in the form of UV LEDs. The UV LEDs 64 are mounted to the underside of the floor 15 oppositely disposed from the visible light LEDs 17. The UV LEDs are electrically coupled to the circuitry 19 and may include a separate on/off switch for controlling the activation of the UV LEDs 64. The UV LEDs 64 face the adhesive board 60 to (UV) illuminate the insect collection or UV light space or chamber 56. The spacing between the mounting board 60 and the visible light housing portion 11 defines the insect trapping portion 12, and specifically the UV light chamber 56, as having open sides 67 which allow the entrance of insects from the peripheral or side areas of the insect trap light 10 rather than the forward facing area of the insect trap light 10 when oriented or mounted upon a vertical wall. Preferably, the bottom side is closed to prevent insects from falling out of the insect trapping portion 12.

In use, the insect trap light 10 is mounted to a vertical support or supporting wall SW of an enclosure such as a room, restaurant, kitchen, etc. The insect trap light 10 is mounted by passing mounting screws 55 through the keyhole shaped mounting holes 54 within the mounting plate 49 and into the room's vertical supporting wall holding the insect trap light 10. For convenience, the mounting screws 55 may not be tightened all the way so that the insect trap light 10 may be easily removed by sliding it upwardly so that the heads of the mounting screws are positioned within the larger portion of the keyhole shaped mounting holes to allow the passage of the mounting screw heads through the mounting holes 54.

The insect trap light 10 has the logo plate 38 which is colored or provided with a decorative overlay 39 which may be associated with the name of the restaurant, food or beverage product, or other decorative indicia. The illumination of the white LEDs 17 creates visible or white light which passes through the light diffuser plate 37 and through the logo plate 38, and/or the overlay 39, so that the light illuminates the graphics associated with the logo plate 38. As such, the insect trap light 10 provides an advertising or decorative visible light source. The illumination of the white light may be controlled through the on/off switch associated with the while LEDs 17.

The illumination of the UV LEDs 64 provides UV light within the insect collection or UV light chamber 56. This UV light is visible through the open sides 67 of the insect trapping housing portion 12. However, this UV light is not directly visible to a person facing the front of the insect trap light 10 as there are no openings from the insect trapping housing portion 12 which face in the front direction. The term forward or front direction described herein is meant to describe a direction extending horizontally from the insect trap light 10 and generally parallel to the floor of a room and/or perpendicular to the vertical support wall of the room. As such, a person within the room which contains the insect trap light 10 does not usually see the UV LEDs 64 or the light produced by such UV LEDs. The UV light produced by UV LEDs is invisible to the human eye, however, these UV LEDs also produce a visible, purple or blue colored light which people commonly associate with UV lights, and it is this visible purple light from the UV LEDs which the person does not readily see or recognize because of the orientation of the openings to the UV light chamber 56 being only upon the open sides 67 and not the front facing surfaces of the insect trap light 10.

With the illumination of the UV LEDs 64, insects within the room may be attracted to the location of the UV LEDs 64 within the insect trapping housing portion 12. Once drawn into the insect trapping housing portion 12, the insect may readily contact the second adhesive surface 63 of the adhesive strips 61, thereby becoming stuck to the adhesive strip 61. Once the adhesive strip 61 has captured a sufficient number of insects or after a set time frame, the adhesive strip 61 may be replaced with a fresh adhesive strip 61. This task is accomplished by simply sliding the adhesive board 60 out of the insect trapping housing portion 12 through sliding cooperation with the L-shaped guides 58. The adhesive strips 61 may then be peeled off the adhesive board 60 and replaced.

It should be understood that the UV light produced by the UV LEDs 64 is separate and apart from the visible light produced by the visible or white light LEDs 17. As such, the white light from visible LEDs 17 may be utilized for decorative or advertising purposes while the UV light from UV LEDs 64 is used for insect trapping purposes. Each may also operate separately or apart from each other through their respective on/off switches associated with the LED circuitry 19.

The illuminated portion provides an advertising media or opportunity through the logo associated with the logo plate 38. Hence, a bar may include a selected brand of beer as the indicia of the logo plate, which may be subsidized by the beer manufacturer as well as a promotional item.

It should also be understood that the visible light housing portion 11 and its visible light chamber 40 is separate from the UV light chamber 56 so that insects drawn to the UV light cannot migrate into the visible light chamber 40.

It should also be understood that the UV light from the UV LEDs is greatly hidden from direct view as it is not visible from the front side of the insect trap light 10. By hiding the UV light (purple colored light glow) from view, patrons of food establishments are not reminded and disgusted by the thought of insects during their dining experience.

It should be understood that the light diffuser plate 37 and logo plate 38 are shown generally even with the side wall member 23 of the frame 18. However, these plates 37 and 38 may be configured to extend past the side wall members 23 to block the view of the open sides 67 of the insect trapping housing portion 12 to a larger extent.

It should be understood that the logo plate may be easily removably and replaceable to enable the logo thereon to be changed.

It should be understood that the light diffuser plate 37 and the logo plate 37 may be combined into one plate. It is preferred to have these as two separate plates as this provides for a manner of easily changing the logo or design associated with the logo plate 37. The combined plates may be referenced herein as either a diffuser plate or a logo plate as it has the characteristics of both.

With reference next to FIG. 5 of the drawings, there is shown an insect trapping light 110 according to the present invention in an alternative embodiment. The insect trapping light 110 is typically mounted to a vertical supporting wall of a room. The insect trapping light 110 includes a visible light housing portion, enclosure, or housing 111 and an insect trapping housing portion, enclosure or housing 112 coupled to the visible light housing 111.

As shown in the drawings, the insect trapping light 110 is generally rectangular or box shaped, however, it should be understood that the insect trapping light 110, the visible light housing 111, and/or the insect trapping housing 112 may be of any shape or configuration.

The visible light housing 111 includes an electronic display screen mounting plate or floor 115 to which is coupled an electronic display screen 117, preferably in the form of an LED, OLED, liquid crystal, or the like display screen. The visible light housing 111 may also include a rectangular, peripheral frame 118 that sandwiches the electronic display screen 117 between the frame 118 and electronic display screen mounting plate 115. The display screen 117 includes all the electronic components necessary to operate the display screen as a television screen, picture display screen, movie display screen, computer monitor (including a computer tablet or display), or the like, which in turn is coupled to an electric power source. The LED circuitry 119 may include an on/off switch for the display screen 117.

The insect trapping housing 112 has keyhole shaped mounting holes 154 extending therethrough which are configured to receive mounting screws that extend into a supporting wall of a room.

The insect trapping housing 112 has a bottom space 130 configured to removably receive an insect bait tray 132. The insect bait tray may be filled with an insect baiting substance to attract insects. The insect bait tray 132 includes a gripping handle 134. The bait tray 132 may include a first magnet portion 133 which is magnetically attracted to a second magnetic portion 135 mounted within the housing 112 to releasably restrict or maintain the stowed position of the bait tray 132. The first and second magnetic portions may both be magnets or may be a magnet and a magnetically attractive metal.

The insect trapping housing 112 and the electronic display screen mounting plate 115 combine to form a UV light space or chamber 156 therebetween.

An adhesive board 160 is slidably received and held in place upon the electronic display screen mounting plate 115 surface facing the UV light chamber 156. The adhesive board 160 may be coupled to the electronic display screen mounting plate 115 by any conventionally know means, such as the previously described L-shaped rails, removable adhesive strips, or the like.

The insect trapping housing portion 112 also includes a matrix or array of UV lights or light sources 164, preferably in the form of UV LEDs. The UV LEDs 164 are mounted to the inside or interior surface of the insect trapping housing 112 facing the adhesive board 160. The UV LEDs are electrically coupled to the circuitry 119 and may include a separate on/off switch for controlling the activation of the UV LEDs 164. The UV LEDs 164 face the adhesive board 160 to (UV) illuminate the insect collection or UV light space or chamber 156. The UV light chamber 156 has side openings or open sides 167 which allow the entrance of insects from the peripheral or side areas of the insect trap light 110 rather than the forward facing area of the insect trap light 110 when oriented or mounted upon a vertical wall.

In use, the insect trap light 110 is mounted to a vertical support or supporting wall SW of an enclosure such as a room, restaurant, kitchen, etc. The insect trap light 110 is mounted by passing mounting screws through the keyhole shaped mounting holes 154 within the insect trapping housing 112 and into the room's vertical supporting wall holding the insect trap light 110. For convenience, the mounting screws may not be tightened all the way so that the insect trap light 110 may be easily removed by sliding it upwardly so that the heads of the mounting screws are positioned within the larger portion of the keyhole shaped mounting holes to allow the passage of the mounting screw heads through the mounting holes 154.

The insect trap light 110 has the electronic display screen 117 which may be energized and include any photographic or video graphic images, such as the name of the restaurant, food or beverage product, decorative indicia, television programs, video commercials, pre-recorded videos, streaming videos, or the like. As such, the insect trap light 110 may provide an advertising or decorative visible light source. The illumination of the electronic display screen 117 may be controlled through the on/off switch associated with the electronic display screen 117.

The insect bait tray 132 is filled with an insect attractant and placed within the bottom space 130 of the UV light chamber 156.

The illumination of the UV LEDs 164 provides UV light within the insect collection or UV light chamber 156. This UV light is visible through the open sides 167 of the insect trapping housing portion 112. However, this UV light is not directly visible to a person facing the front of the insect trap light 110 as there are no openings from the insect trapping housing portion 112 which face in the front direction. The term forward or front direction described herein is meant to describe a direction extending horizontally from the insect trap light 110 and generally parallel to the floor of a room and/or perpendicular to the vertical support wall of the room. As such, a person within the room which contains the insect trap light 110 does not usually see the UV LEDs 164 or the light produced by such UV LEDs. The UV light produced by UV LEDs is invisible to the human eye, however, these UV LEDs also produce a visible, purple or blue colored light which people commonly associate with UV lights, and it is this visible purple light from the UV LEDs which the person does not readily see or recognize because of the orientation of the openings to the UV light chamber 156 being only upon the open sides 167 and not the front facing surfaces of the insect trap light 110.

With the illumination of the UV LEDs 164, insects within the room may be attracted to the location of the UV LEDs 164 within the insect trapping housing portion 112 or UV light chamber 156. Once drawn into the insect trapping housing portion 112, the insect may readily contact the adhesive surface of the adhesive board 160, thereby becoming stuck to the adhesive board 160. Once the adhesive board 160 has captured a sufficient number of insects or after a set time frame, the adhesive board 160 may be replaced with a fresh adhesive board 160. This task is accomplished by simply sliding the adhesive board 160 out of the insect trapping housing portion 112 through sliding cooperation with the L-shaped guides.

It should be understood that the UV light produced by the UV LEDs 164 is separate and apart from the visible light produced by the electronic display screen 117. As such, the electronic display screen 117 may be utilized for decorative or advertising purposes while the UV light from UV LEDs 164 is used for insect trapping purposes. Each may also operate separately or apart from each other through their respective on/off switches associated with the LED circuitry 119.

It should also be understood that the UV light from the UV LEDs is greatly hidden from direct view as it is not visible from the front side of the insect trap light 110. By hiding the UV light (purple colored light glow) from view, patrons of food establishments are not reminded and disgusted by the thought of insects during their dining experience.

The insect trap light may have a generally flat bottom surface to enable the insect trap light to stand upright upon a supporting surface, such as a countertop, table, or the like. Furthermore, the insect trap light may include a kickstand or mount that enable the insect trap light to be placed upon a supporting surface in a tilted position.

The insect trap light may also have a side wall member or other portion of the rectangular frame as a separate piece to enable it to be removed for easier access to the interior of the insect trap light, for example for removal of the adhesive board, changing of the light, changing or cleaning of the diffuser plate 37, changing of the logo plate 38, or the like. The removable portion of the frame may be maintained in the final position through any conventional means, such as magnets, clips, detents, etc.

The insect trap light may also be mounted to a wall using a cleat type mounting system. The housing may include a projection that is configured to rest within a cleat recess so as to enable lateral adjustment of the housing relative to the cleat.

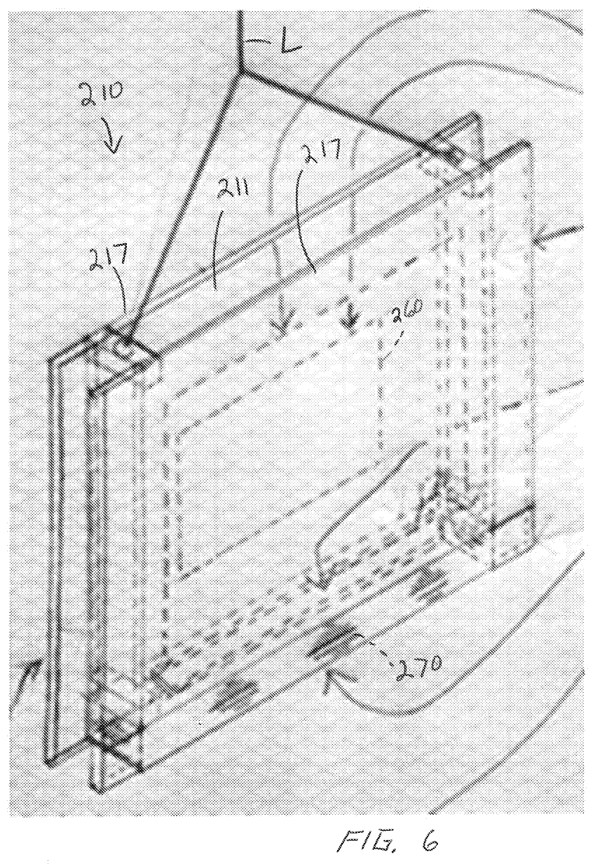

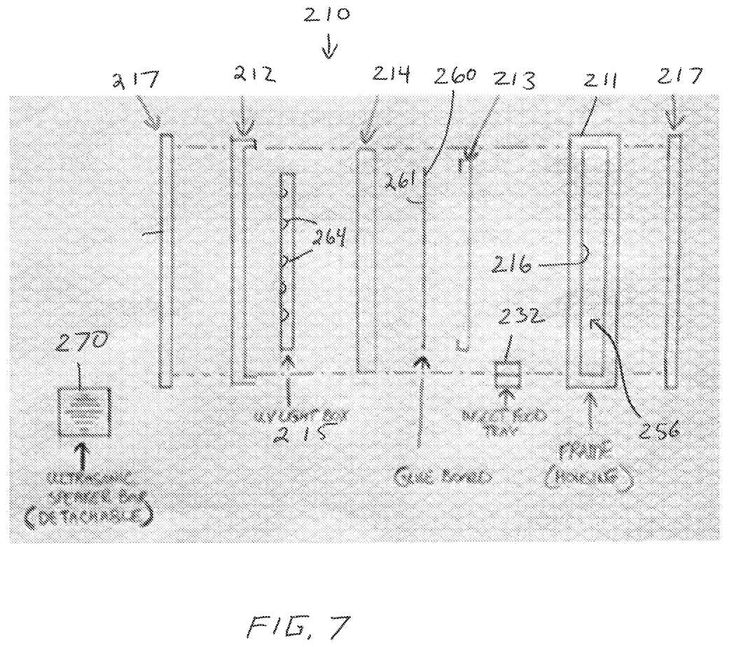

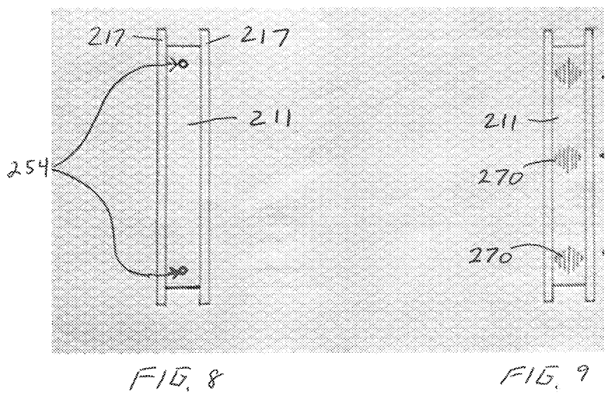

With reference next to FIGS. 6-9 of the drawings, there is shown an insect trapping light 210 according to the present invention in an alternative embodiment. The insect trapping light 210 is typically mounted to a vertical supporting wall of a room above or adjacent to a window or other open space so that the insect trapping light 210 may be viewed from two opposite directions or areas. The insect trapping light 210 includes a housing portion, enclosure, frame, or housing 211 and an insect trapping housing portion, enclosure or housing 212 coupled to the housing 211. The housing 211 also includes adhesive board guide or track 213. The housing 211 also has an angled side vane, louver, or blind 214 that is positioned within each side opening 216 extending through the side of the housing 211.

As shown in the drawings, the insect trapping light 210 is generally rectangular or box shaped, however, it should be understood that the insect trapping light 210, the housing 211, and/or the insect trapping housing 212 may be of any shape or configuration. Obviously, the embodiment shown is rectangular because of the inclusion of a rectangular electronic display screens 217 described later. The housing 211 may be considered to be a visible light housing as it holds the electronic display screens 217.

An electronic display screen 217, preferably in the form of an LED, OLED, liquid crystal, or the like display screen, is coupled to each side of the frame 211. The display screens 217 includes all the electronic components necessary to operate the display screen as a television screen, picture display screen, movie display screen, computer monitor (including a computer tablet or display), or the like, along with the necessary wires and transformers necessary to operate, which in turn is coupled to an electric power source. The LED circuitry may include an on/off switch for the electronic display screen 217 or may be operationally incorporated into the screen itself or as a software component. The electronic display screens 217 (first and second electronic display screens) are positioned so that the viewable portion of the electronic display screens 217 face away from each other, i.e., the face in opposite directions.

The insect trapping housing 212 has a mounting holes 254 extending therethrough which are configured to receive mounting wires or lines L so that the insect trapping light 210 may be suspended from a window frame, wall, ceiling or other stable object.

The housing 211 has a bottom space configured to removably receive an insect bait tray 232. The insect bait tray may be filled with an insect baiting substance to attract insects. As previously described, the insect bait tray 232 may include a gripping handle, and magnet portions which is magnetically attracted to a second magnetic portion mounted within the housing 212 to releasably restrict or maintain the stowed position of the bait tray 232. The first and second magnetic portions may both be magnets or may be a magnet and a magnetically attractive metal.

The housing 211 may also include a space to house a scent generating device 220, such as a scent diffuser, that produces a pleasant scent for humans or even pests that are intended to be trapped. This scent generating device 220 may produce a scent which offsets or overwhelm any potential unpleasant scent generated by the insect bait tray 232.

The insect trapping housing 212 and the frame 211 combine to form a UV light space or chamber 256 therebetween. An adhesive board 260 is slidably received and held in place within the UV light chamber 256 so that its adhesive surface 261 is facing the UV light chamber 256 with the aid of the guides 213. However, the adhesive board 260 may be mounted through any conventionally known means, such as the previously described L-shaped rails, removable adhesive strips, or the like.

A UV light box 215 is mounted within the UV light chamber 256. The UV light box 215 includes a matrix or array of UV lights or light sources 264, preferably in the form of UV LEDs. The UV LEDs 264 are mounted to the inside or interior surface of the insect trapping housing 212 facing the adhesive board 260. The UV LEDs are electrically coupled to the circuitry 219 and may include a separate on/off switch for controlling the activation of the UV LEDs 264. The UV LEDs 264 face the adhesive board 260 to (UV) illuminate the insect collection or UV light space or chamber 256. The UV LEDs 264 emit light in an unencumbered or unobstructed path directly upon the adhesive surface of the adhesive board 260. The UV light chamber 256 has side openings or open sides aligned with housing side openings 216 which allow the UV to exit the UV light chamber yet allow the entrance of insects from the peripheral or side areas of the insect trap light 210 into the UV light chamber 256. The vanes or blinds aid in restricting the viewing of dead insects caught upon the adhesive board 260 while still allowing the passage of UV from the UV light chamber 256.

The insect trapping light 210 may also include an optional electronic speaker 270 which preferably extends through the bottom of the housing 211. The speaker 270 may be operated to produce a pest (rodents or insects) repelling sound. The speaker 270 may be detachable from the frame 211 and may include its own separate power source and on/off switch to enable the speaker 270 to be detached as positioned at another location remote from the remaining insect trapping device. This may be done in order to drive insects towards the remaining insect trapping device to aid in capturing more insects.

In use, the insect trap light 210 is coupled to wire(s) or line(s) L so as to be suspended, which allows the insect trap light 210 to be positioned adjacent a window or opening and viewed from both sides, i.e., both inside and outside the establishment, such as a room, restaurant, kitchen, etc. or between two different rooms or areas. To do so, the insect trap light 210 is mounted by passing the mounting wires through mounting holes 254 within the insect trapping housing 212 and attaching the mounting wires to the structure of the room, such as its walls or ceiling.

The insect trap light 210 has the electronic display screens 217 which may be energized and include any photographic or video graphic images, such as the name of the restaurant, food or beverage product, decorative indicia, television programs, video commercials, pre-recorded videos, streaming videos, or the like. Each electronic display screen 217 may display the same item or may display different items so that someone viewing from outside the establishment is viewing content that is different from those viewing from inside the establishment. For examiner, the electronic display screen facing outside may be displaying the restaurant's menu while the display screen facing the inside may be displaying a sports channel or select promotional item. As such, the insect trap light 210 may provide an advertising or decorative visible light source. The illumination of the electronic display screens 217 may be controlled through the on/off switch associated with each of the electronic display screen 217.

The insect bait tray 232 is filled with an insect attractant and placed within the bottom space 230 of the UV light chamber 256.

The illumination of the UV LEDs 264 provides UV light within the insect collection or UV light chamber 256. This UV light is visible through the open sides of the insect trapping housing portion 212. However, this UV light is not directly visible to a person facing the front of the insect trap light 210 as there are no openings from the insect trapping housing portion 212 which face in the front direction. The term forward or front direction described herein is meant to describe a direction extending horizontally from the insect trap light 210 and generally parallel to the floor of a room and/or perpendicular to the vertical support wall of the room. As such, a person within the room which contains the insect trap light 210 does not usually see the UV LEDs 264 or the light produced by such UV LEDs. The UV light produced by UV LEDs is invisible to the human eye, however, these UV LEDs also produce a visible, purple or blue colored light which people commonly associate with UV lights, and it is this visible purple light from the UV LEDs which the person does not readily see or recognize because of the orientation of the openings to the UV light chamber 256 being only upon the open sides 267 and not the front facing surfaces of the insect trap light 210. The vanes or blinds 213 may further limit the viewing of the adhesive board 160.

With the illumination of the UV LEDs 264, insects within the room may be attracted to the location of the UV LEDs 264 within the insect trapping housing portion 212 or UV light chamber 256. Once drawn into the insect trapping light 210, the insect may readily contact the adhesive surface of the adhesive board 260 that is unencumbered by structure between the UV LEDs 264 and the adhesive surface 261, thereby becoming stuck to the adhesive board 260. Once the adhesive board 260 has captured a sufficient number of insects or after a set time frame, the adhesive board 260 may be replaced with a fresh adhesive board 260. This task is accomplished by simply sliding the adhesive board 260 out of the insect trapping housing portion 212 through sliding cooperation with the guides 213.

It should be understood that the UV light produced by the UV LEDs 264 is separate and apart from the visible light produced by the electronic display screen 217. As such, the electronic display screen 217 may be utilized for decorative or advertising purposes while the UV light from UV LEDs 264 is used for insect trapping purposes. Each may also operate separately or apart from each other through their respective on/off switches associated with the LED circuitry.

It should also be understood that the UV light from the UV LEDs is greatly hidden from direct view as it is not visible from the front side of the insect trap light 210. By hiding the UV light (purple colored light glow) from view, patrons of food establishments are not reminded and disgusted by the thought of insects during their dining experience.

The insect trap light may have a generally flat bottom surface to enable the insect trap light to stand upright upon a supporting surface, such as a countertop, table, or the like. Furthermore, the insect trap light may include a kickstand or mount that enable the insect trap light to be placed upon a supporting surface in a tilted position.

The insect trap light may also have a side wall member or other portion of the rectangular frame as a separate piece to enable it to be removed for easier access to the interior of the insect trap light, for example for removal of the adhesive board, changing of the light, changing or cleaning of components, or the like. The removable portion of the frame may be maintained in the final position through any conventional means, such as magnets, clips, detents, etc.

It thus is seen that an insect trap light is now provided which overcomes problems associated with the prior art. While this invention has been described in detail with particular references to the preferred embodiments thereof, it should be understood that many modifications, additions and deletions, in addition to those expressly recited, may be made thereto without departure from the spirit and scope of the invention as set forth in the following claims.

1. An insect trap light comprising:
a first electronic display screen;
a second electronic display screen;
an insect trapping housing portion coupled between said first electronic display screen and said second electronic display screen, said insect trapping housing portion creating an ultraviolet light chamber;
an ultraviolet light source mounted within said ultraviolet light chamber, and
an adhesive board removably mounted within said ultraviolet light chamber.

2. The insect trap light of claim 1 wherein said first electronic display screen is considered a front surface, said second electronic display screen is considered a rear surface, and said ultraviolet light chamber includes side openings extending between said first electronic display screen and said second electronic display screen.

3. The insect trap light of claim 1 wherein said ultraviolet light chamber includes side opening include a vane for restricting viewing through said side opening.

4. The insect trap light of claim 1 wherein said first electronic display screen is a television.

5. The insect trap light of claim 1 wherein said first electronic display screen is an electronic image display or video player.

6. The insect trap light of claim 1 wherein said first electronic display screen is a computer monitor.

7. The insect trap light of claim 1 further comprising an attractive scent producing device.

8. The insect trap light of claim 1 further comprising a removable insect attractant bait tray.

9. The insect trap light of claim 1 further comprising at least one sound speaker.

10. The insect trap light of claim 9 wherein said at least one sound speaker is removable and includes a power source.

11. An insect trap light comprising:
a frame having a floor;
peripheral sidewalls extending from said floor;
a first electronic display screen coupled to said frame facing in a first direction;
a second electronic display screen coupled to said frame and facing in a direction opposite to said first direction;
an ultraviolet light source coupled to said frame, and
an adhesive board removably mounted to said frame in a position facing said ultraviolet light source.

12. The insect trap light of claim 11 wherein said first electronic display screen is considered a front surface, said peripheral sidewalls include side openings extending between said first electronic display screen and said second electronic display screen.

13. The insect trap light of claim 11 wherein the combination of said frame and said electronic display screens define an ultraviolet light chamber, and wherein said ultraviolet light source is mounted with said ultraviolet light chamber.

14. The insect trap light of claim 13 wherein said ultraviolet light chamber includes side openings.

15. The insect trap light of claim 11 wherein said first electronic display screen is a television.

16. The insect trap light of claim 11 wherein said first electronic display screen is an electronic image or video player.

17. The insect trap light of claim 11 wherein said first electronic display screen is a computer monitor.

18. The insect trap light of claim 11 further comprising an attractive scent producing device.

19. The insect trap light of claim 11 further comprising a bait tray for holding an insect attractant.

20. The insect trap light of claim 11 further comprising at least one sound speaker.

21. The insect trap light of claim 20 wherein said at least one sound speaker is removable from said frame.

22. An insect trap light mountable to a vertical support surface, said insect trap light comprising:
a pair of oppositely facing electronic display screens;
an ultraviolet light chamber coupled to said pair of electronic display screens;
an ultraviolet light source mounted within said ultraviolet light chamber, and an adhesive board removably mounted within said ultraviolet light chamber.

23. The insect trap light of claim 22 wherein said ultraviolet light chamber includes side openings.
